(19) United States
(12) Patent Application Publication
(10) Pub. No.: US 2025/0081040 A1
(43) Pub. Date: Mar. 6, 2025

(54) MULTI-LINK OPERATION LOAD BALANCING FOR A VIRTUAL ACCESS POINT

(71) Applicant: Cisco Technology, Inc., San Jose, CA (US)

(72) Inventors: Pascal Thubert, Roquefort les Pins (FR); Jerome HENRY, Pittsboro, NC (US)

(21) Appl. No.: 18/242,751

(22) Filed: Sep. 6, 2023

(51) Int. Cl. H04W 28/086

(52) U.S. Cl. CPC H04W 28/0862

(57) ABSTRACT

In one embodiment, a process determines wireless station (STA) load and schedule of two or more access point (AP) radios. The process then develops a coordination between the two or more access point radios to limit downtime for one or more multi-link wireless devices capable of multi-link operation (MLO) on two or more channels. The process further causes the one or more multi-link wireless devices to move between access point radios based on the wireless station load and schedule and according to the coordination.

### TECHNICAL FIELD

The present disclosure relates generally to computer networks, and, more particularly, to multi-link operation load balancing for a virtual access point.

### BACKGROUND

Virtual access points (VAPs) may be used to avoid scenarios in which an industrial client station (STA) needs to roam when connected to Wi-Fi. As used herein, “roaming” generally implies progressively losing optimal connection to the current access point (AP), which may be evidenced by the detection of events associated with failed transmissions, the occurrence of rate shifting, and/or performance of retry operations before the STA gives up, followed by performance of operations to scan for better APs to connect to, then moving the association to the best-found candidate next AP.

These events (e.g., events associated with a roaming condition being experienced) consume time and are disruptive to STA operations. Short disruptions may be acceptable for unscheduled traffic on human-controlled devices, such as smartphones, tablets, etc. that have the capability of performing actions such as “real time” voice or video calls (where the STA can buffer a particular quantity of data in an attempt to absorb these types of events). However, such disruptions may be less tolerable in deployments that involve Internet of Things (IoT) objects, particularly in industrial environments, where delay tolerances may be tighter than in consumer deployments.

As the number of and/or density of STAs increases, the VAP infrastructure may allow a given AP radio to operate on more than one channel in an effort to avoid a single collision domain event. By operating different VAPs on different channels, a radio thus limits the collision domain events. In such architectures, the AP generally may need to temporarily leave the current channel (to serve another STA on another channel). In the VAP infrastructure, the VAP may inform the STA that it should stay silent for some interval while the AP shifts to the other channel. The STA is generally then scheduled again as the VAP comes back to the STA channel.

As the number of STAs increases, the need for more channels also mechanically increases (although there can be many STAs on a given channel), and thus the need for the VAP to schedule the STA silences and Transmit/Receive cycles. This need is associated with additional scheduling complexity, and also a decreased available airtime for each STA on each channel.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example of duplicate elimination in a network;

FIG. 4 illustrates an example of collision domain reduction in a network; and

FIG. 5 illustrates an example simplified procedure for multi-link operation load balancing for a virtual access point.

### DESCRIPTION OF EXAMPLE EMBODIMENTS

### Overview

According to one or more embodiments of the disclosure, a process determines wireless station (STA) load and schedule of two or more access point (AP) radios. The process then develops a coordination between the two or more access point radios to limit downtime for one or more multi-link wireless devices capable of multi-link operation (MLO) on two or more channels. The process further causes the one or more multi-link wireless devices to move between access point radios based on the wireless station load and schedule and according to the coordination.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to edge endpoints to provide computing, storage, and networking resources and services. Multiple edge nodes organized or configured together form an edge system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

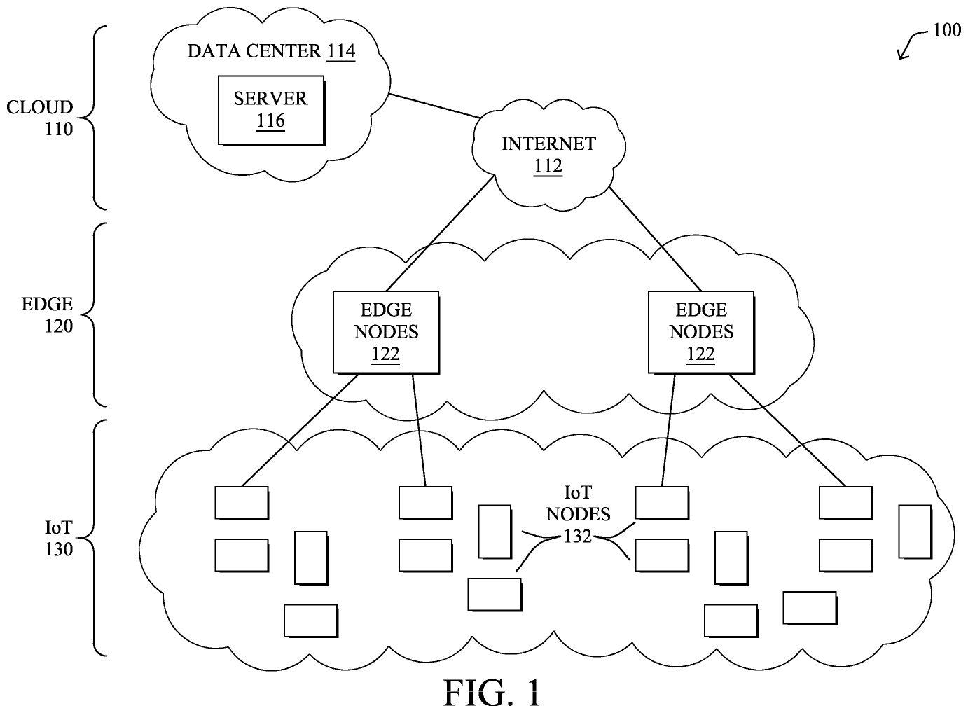

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, edge layer 120, and IoT device layer 130. Illustratively, cloud layer 110 may comprise general connectivity via the Internet 112, and may contain one or more datacenters 114 with one or more centralized servers 116 or other devices, as will be appreciated by those skilled in the art. Within edge layer 120, various edge nodes/devices 122 (e.g., with edge modules, described below) may execute various edge computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), PLC protocols, or other shared-media protocols where appropriate. In this context, a protocol consists of a set of rules defining how the nodes interact with each other.

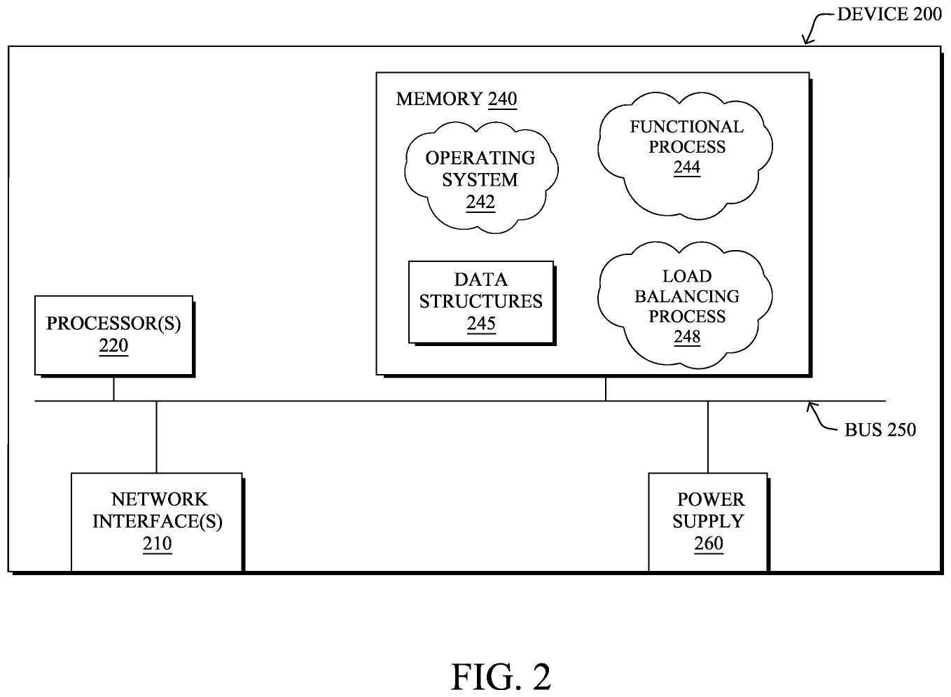

FIG. 2 is a schematic block diagram of an example node/device 200 (e.g., apparatus) that may be used with one or more embodiments described herein e.g., as any of the nodes or devices shown in FIG. 1 above or described in further detail below. The device 200 may also be any other suitable type of device depending upon the type of network architecture in place, such as IoT nodes, etc. Device 200 comprises one or more network interfaces 210 (e.g., wired, wireless, PLC, etc.), one or more processors 220, and a memory 240 interconnected by a system bus 250, and is powered by a power supply 260 (e.g., battery, plug-in, etc.).

The network interfaces 210 include the mechanical, electrical, and signaling circuitry for communicating data over physical links coupled to the network 100. The network interfaces may be configured to transmit and/or receive data using a variety of different communication protocols. Note, further, that the nodes may have two different types of network connections, e.g., wireless and wired/physical connections, and that the view herein is merely for illustration. Also, while the network interface 210 is shown separately from power supply 260, for PLC the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. Operating system 242, portions of which is typically resident in memory 240 and executed by the processor, functionally organizes the device by, inter alia, invoking operations in support of software processes and/or services executing on the device. These software processors and/or services may comprise one or more functional processes 244, and illustratively, a load balancing process 248 (e.g., a multi-link operation load balancing process for a virtual access point), as described herein, any of which may alternatively be located within individual network interfaces. Note that while load balancing process 248 is shown in centralized memory 240, alternative embodiments provide for the process to be specifically operated within the network interfaces 210, such as a component of a MAC layer.

Notably, functional processes 244, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, an IoT device would be configured to operate as an IoT device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, load balancing process 248 includes computer executable instructions (e.g., a process or method) that, when executed by processor(s) 220, cause device 200 to limit downtime for one or more multi-link wireless devices capable of multi-link operation on two or more channels, as described in greater detail below. For example, the load balancing process 248 includes computer executable instructions that, when executed by processor(s) 220, cause device 200 to determine wireless station load and schedule of two or more access point radios, determine coordination between the two or more access point radios to limit downtime for one or more multi-link wireless devices capable of multi-link operation on two or more channels, and/or cause the one or more multi-link wireless devices to move between access point radios based on the wireless station load and schedule and according to the coordination, among other functions described in more detail herein.

As noted above, as the density of STAs (or nodes) on a network increases, the VAP infrastructure may need to allow AP radios to operate on more than one channel; however, it may become challenging to provide adequate coverage to the STAs (or nodes) due to the scheduling complexity and potential for decreased airtime, particularly as the density of STAs (or nodes) increases.

### Multi-Link Operation Load Balancing for a Virtual Access Point

The techniques herein allow for multi-link operation (MLO) whereby one station (STA), which may be referred to in the alternative as a “node” or “device” herein, can spread an associated virtual access point (VAP) across two distinct frequencies (referred to in the alternative as “channels”). Aspects of the present disclosure further allow for these frequencies to be distributed across the STAs in a random or oriented manner and allow a controller to influence the STAs to use more or less of each of the frequencies that are allocated to the STAs. This allows the controller to dynamically remove traffic from some channels (e.g., for sustainability, or to avoid AP channel flapping phenomena) and/or balance the traffic between the remaining channels to reach a global balance for the STAs and/or for a network in which the STAs operate.

Although the following non-limited examples are described in terms of STAs or “nodes,” embodiments of the disclosure are not so limited (e.g., are not limited merely to Wi-Fi deployments that typically include STAs) and the disclosure is applicable to any multi-link device (MLD), whether such MLD is deployed in a Wi-Fi network or other type of network. In addition, it is notes that, for Bluetooth Low Energy (BLE) applications, the role of the AP may be that of a central role, while a STA may be referred to as a peripheral. Further, as some embodiments herein are applicable to IoT devices, it is noted that, in some embodiments, BLE may provide the capabilities described herein for IoT reliability (e.g., for “Reliable and Available Wireless” or “RAW”, as may be appreciated by those skilled in the art).

For example, aspects of the present disclosure leverage MLO to increase the time availability for each STA with said STA's corresponding VAP. In contrast to some previous approaches, the disclosure generally does not seek to double the number of connections to double the available airtime, but rather to use MLO to suppress available downtime. In some embodiments, as described in more detail herein, a procedure for utilizing MLO to suppress available downtime may include the following operations:
A STA associates to a VAP in accordance with generally known procedures. As is expected in an MLO context, the STA connects to two basic service set identifiers (BSSIDs), e.g., two radios on a single AP or on two APs, that form a VAP pair;
The two radios exchange their STA load and schedule (directly, or both report to a wireless LAN controller (WLC)). As mentioned above, the exchange may be either over the wire or over the air. In some embodiments, the load represents the airtime consumed over a given channel for each multi-link device (MLD) on the AP, while the schedule represents the AP time slice on each channel (if the AP has to hop between channels); and
The two radios coordinate to limit the downtime (e.g., the time where an active AP is unavailable) for each MLD STA. In one embodiment, one radio may send a sleep bit set (signaling that the AP becomes unavailable when, for example, the AP jumps to another channel) at the time when the other radio sends a sleep bit unset (e.g., signaling that the AP is present and available). Likewise, when target wake time (TWT) techniques are used, a STA is given a TWT on one radio that coordinates with the TWT on the other radio, so that there is always at least one radio on the STA that is up and ready to transmit or receive.

In addition, or in the alternative, aspects of the present disclosure provide for a “roamless” roam feature to be provided. It is noted that, although the term “roam” is widely used herein for simplicity, embodiments of the disclosure allow for scenarios in which “roaming” comprises not changing a BSS for the STA, but rather using the same BSS on a different VAP. An example procedure for realizing the roamless roam feature may be as follows:

In the roamless roam mode, the MLD STA is associated to two AP radios (AP1 and AP2) in accordance with generally known procedures. One AP radio (AP2) may be heavily loaded as described above (either because it has too many STAs on a given channel, or too many channels to hop through).
Another nearby radio (AP3) may have a lower load and could perform the VAP function (likely on a different channel).
The other active AP radio (AP1) sends to the STA an 802.11k neighbor report, indicating VAP1 BSSID presence on AP3 channel, and instructing the STA to scan that channel. The messages are sent at the beginning of a period where the STA has airtime allocated on AP1.
Meanwhile, AP2 sends a request to roam to the STA. Contrary to the art, the target AP is AP2 BSSID (the VAP), but on AP3 channel. While the STA continues to communicate with VAP1, it also scans, then discovers its VAP on AP3 channel. As the BSSID is the same as AP2, no roaming function is necessary, and the STA continues its exchanges with its VAP on the new channel.

Specifically, according to one or more embodiments of the disclosure as described in detail below, a process determines wireless station (STA) load and schedule of two or more access point (AP) radios. The process then develops a coordination between the two or more access point radios to limit downtime for one or more multi-link wireless devices capable of multi-link operation (MLO) on two or more channels. The process further causes the one or more multi-link wireless devices to move between access point radios based on the wireless station load and schedule and according to the coordination.

Illustratively, the techniques described herein may be performed by hardware, software, and/or firmware, such as in accordance with the load balancing process 248, which may include computer executable instructions executed by the processor 220 (or independent processor of interfaces 210) to perform functions relating to the techniques described herein, e.g., in conjunction with functional process 244.

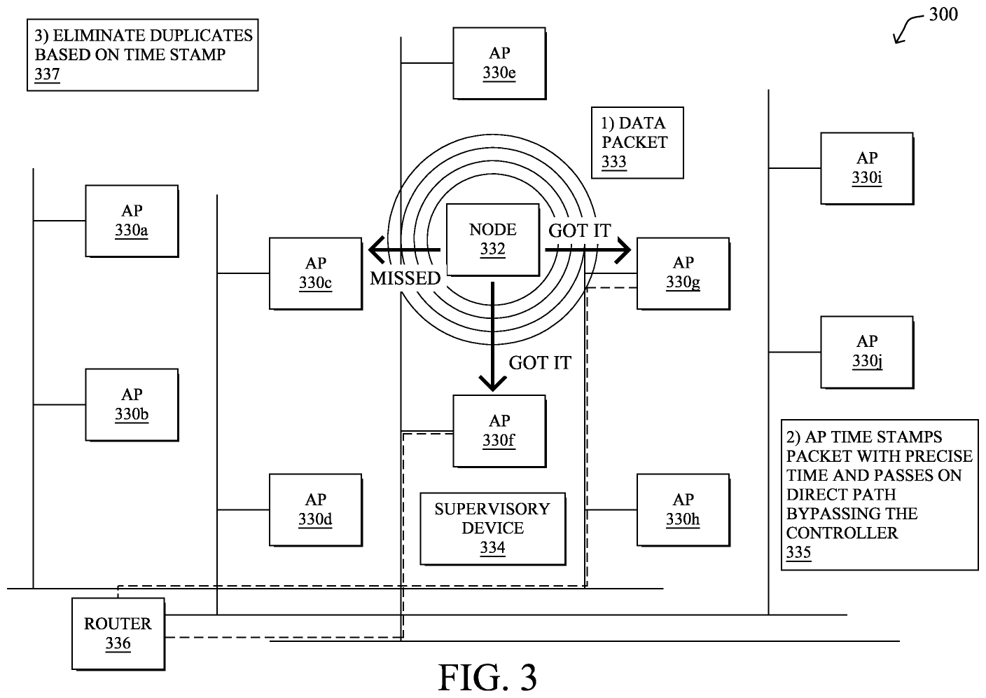

Operationally, FIG. 3 illustrates an example of duplicate elimination in a network 300. As shown in FIG. 3, assume that there exists a portion of a network 300 that includes a plurality of APs (e.g., APs 330a-330j) that are located in different physical locations through an area (e.g., a building, campus, etc.). APs 330 may be in communication with a supervisory device 334 in the network, such as a wireless controller, other networking device, or, alternatively, a remote device, such as a server located in a data center or cloud computing environment.

Now, assume that a node 332 (e.g., an edge node, IoT node, client device, mobile device, STA, etc.) is attempting to access the network 300. Once the node 332 is accessing the network 300, it is possible that the node 332 experiences a roaming condition in which the node progressively loses optimal connection to the current AP. However, as mentioned above, if the APs 330 are configured to behave as virtual APs (VAPs), roaming may be avoided by the node 332 by, for example, creating a VAP that moves along with the node 332, because the VAP may suppress roaming for the node 332.

However, as the density of nodes 332 increases, the VAP infrastructure may allow a given AP to operate on more than one channel. This is because a single channel AP 330 can result in a single collision domain. By operating different VAPs on different channels, collision risks for the node 332 may be mitigated. One downside of such architecture is that the AP 330 radio may need to temporarily leave the current channel (e.g., to serve another node 332 on another channel). However, this downside may be counterbalanced by the benefit of reducing the collision domain. For example, the VAP may inform the node 332 that the node 332 should stay silent for some interval while the AP 330 shifts to the other channel. In some embodiments, the node 332 may then be scheduled again as the VAP comes back to the channel being utilized by the node 332.

In addition, as the number of nodes 332 increases, the need for more channels may also mechanically increase (although there can be many nodes 332 on a given channel), and thus the need for the VAP to schedule the node 332 silences and transmit/receive cycles may increase as well. It will be appreciated that this need is associated with additional scheduling complexity, and also a decreased available airtime for each node 332 on each channel of a VAP.

Therefore, it may be beneficial to provide methodologies that allow the node 332 to maintain airtime availability despite an increased quantity of nodes 332 on the network 300 (and thus an increased quantity of served channels per AP 330 radio), particularly in IoT deployments. Accordingly, embodiments of the present disclosure contemplate such methodologies.

For example, as shown in FIG. 3, at operation 333 a data packet is communicated between the node 332 and a subset of the APs. In this particular example, the subset of APs includes AP 330c (which misses the data packet) and APs 330f and 330g, which get the data packet.

As shown at operation 335, the AP(s) (e.g., the APs 330f and/or 330g) time stamps the data packet from operation 333. In the example of FIG. 3, the AP(s) time stamp the data packet with a precise time and proceed to pass the data packet on a direct path that bypasses the supervisory device 334.

Next, at operation 337, the router 336 can eliminate duplicate data packets based on the time stamp added to the data packet at operation 335. In some embodiments, the duplicate data packets can be eliminated by the router 336 in accordance with deterministic networking (DetNet) processes, such as a DetNet egress process.

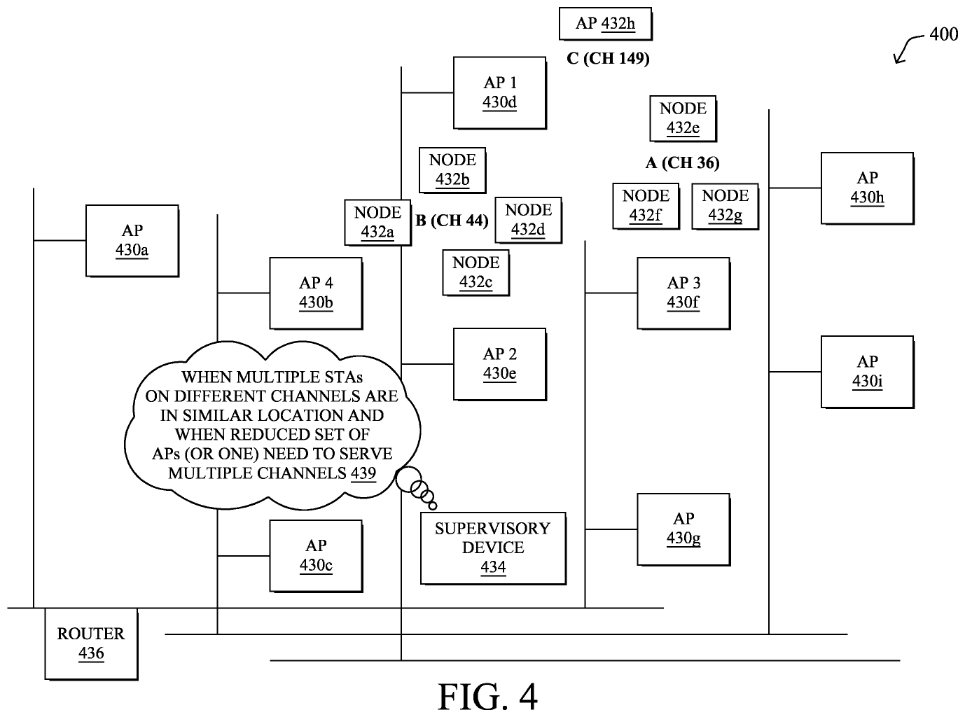

FIG. 4 illustrates an example of collision domain reduction in a network 400. The network 400 may be analogous to the network 300 of FIG. 3. For example, as shown in FIG. 4, the network 400 includes a plurality of APs (the APs 430a-430i), which can be analogous to the APs 330 of FIG. 3. In addition, the network 400 includes a plurality of nodes 432a-432h (which can be analogous to the node 332 of FIG. 3) and a router 436 (which can be analogous to the router 336 of FIG. 3).

As shown in FIG. 4, an AP (e.g., the AP 430d) can be operating on a particular channel (e.g., channel 44 in this non-limiting example) to serve nodes 432a, 432b, 432c, and 432d. It is noted that the nodes 432e, 432f, and 432g are associated with a different channel (e.g., channel 36 in this non-limiting example) of the AP 430d and node 432h is associated with yet a different channel (e.g., channel 149 in this non-limiting example).

As mentioned above, as the number of STAs (e.g., the number of nodes 432) on a given channel increases, the collision domain may decrease. That is, assuming that each STA can be associated to a particular VAP such that each of the APs 430 in a STA neighborhood appear with a STA specific BSSID value, which may appear to the STA as a single AP that follows the STA as it moves (e.g., roams), the collision domain may decrease such that each transmission between a STA and its VAP may collide with other transmissions, including between another STA and another VPA on the same channel.

In order to resolve this collision issue using VAPs, embodiments herein allow for spreading the VAPs across different channels. However, as mentioned above, when STAs move, it is possible that multiple STAs, can be on multiple channels that may be in the same area and could therefore be best served by a particular AP (AP 430), as shown at operation 439. Accordingly, the AP 430 may then schedule each STA and/or channel associated with each STA; however, this remedy may limit each STA available time on its channel.

In order to address these and other deficiencies, aspects of the present disclosure allow for load balancing across the channels to be obtained as follows. First, each STA (e.g., each node 432) is assigned a pair of MLO channels (or simply “channels” for brevity) that are chosen randomly between a list of channels that are supported by the APs 430 for VAP.

Then, if a particular channel is determined to be “too busy” (e.g., if the particular channel meets or exceeds a data traffic criterion or set of data traffic criteria), the supervisory device 434 may indicate to the STAs on that channel to use more of their other MLO channel (or to move completely to the other MLO channel, respectively) to distribute the load over the other channels per the random assignment mentioned above. In addition to, or in the alternative, if the supervisory device 434 determines that it is advantageous to completely a channel to, for example, avoid performance of TWT techniques, the supervisory device 434 may indicate to the STAs on that channel to use more of their other MLO channel (or to move completely to the other MLO channel, respectively) to distribute the load over the other channels per the random assignment mentioned above.

Performance of the above operations may, however, cause a ripple effect causing another channel to unintentionally become overloaded. In order to address this scenario, the supervisory device 434 may indicate to the STAs on the other channel that they are still available channels to use in order to balance the data traffic on alternate channels. One or more of the above operations may be performed iteratively in order to achieve a desirable load balancing amongst the STAs and/or channels.

In an illustrative, non-limiting example, consider a scenario in which there are three MLO channels: Ca (e.g., channel 44), Cb (e.g., channel 36), and Cc (e.g., channel 149), and three STAs: STA1, STA2, and STA3 (e.g., nodes 432a, 432f, and 432h, respectively). In this example, suppose that:
STA1 has its MLO set to Ca and Cb,
STA2 has its MLO set to Ca and Cc, and
STA3 has its MLO set to Cb and Cc.

In a full load condition, the supervisory device 434 could determine that:
STA1 uses 100% Ca and 0% Cb,
STA2 uses 100% Cc and 0% Ca, and
STA3 uses 100% Cb and 0% Cc.

However, if the STAs are not fully loaded and, for example, are operating at 50%-60% load, the supervisory device 434 could determine that:
STA1 uses 50% Ca and 50% Cb,
STA2 uses 100% Ca, and
STA3 uses 100% Cb.
   Because channel Cc is not being used by any of the STAs, Cc can be shut down until needed. It will be apparent that as the quantity of STAs, APs, channels, etc. in the network 400 increases, the calculus in the above simplified example may become more complex; however, aspects of the present disclosure may be scaled to account for any number of STAs, APs, channels, etc.

To further clarify how some embodiments of the present disclosure operate, it is noted that embodiments herein provide for MLO in VAP contexts whereby multiple APs are synchronized. Once synchronized, the APs can coordinate with one another while MLO allows for connectivity to STAs or nodes 432 to be maintained while such STAs or nodes 432 roam amongst channels of the APs and/or amongst the APs. As mentioned above, this can provide for load balancing in a network 400 by altering the frequency provided by a VAP. In some embodiments, because the VAP can change its frequency, different frequencies can be provided for communication to different STAs or nodes 432.

That is, in some embodiments, the STAs or nodes 432 can “roam” on different channel frequencies provided by the VAP. Accordingly, in some embodiments, some operations may be performed to synchronize the APs while other operations may be performed to assign STAs or nodes 432 to channels of the VAP. For example, in a case in which there are three physical APs running a same VAP, embodiments herein allow for different APs to be used by changing the frequency and, hence, the channel used for communication with the STAs or nodes 432.

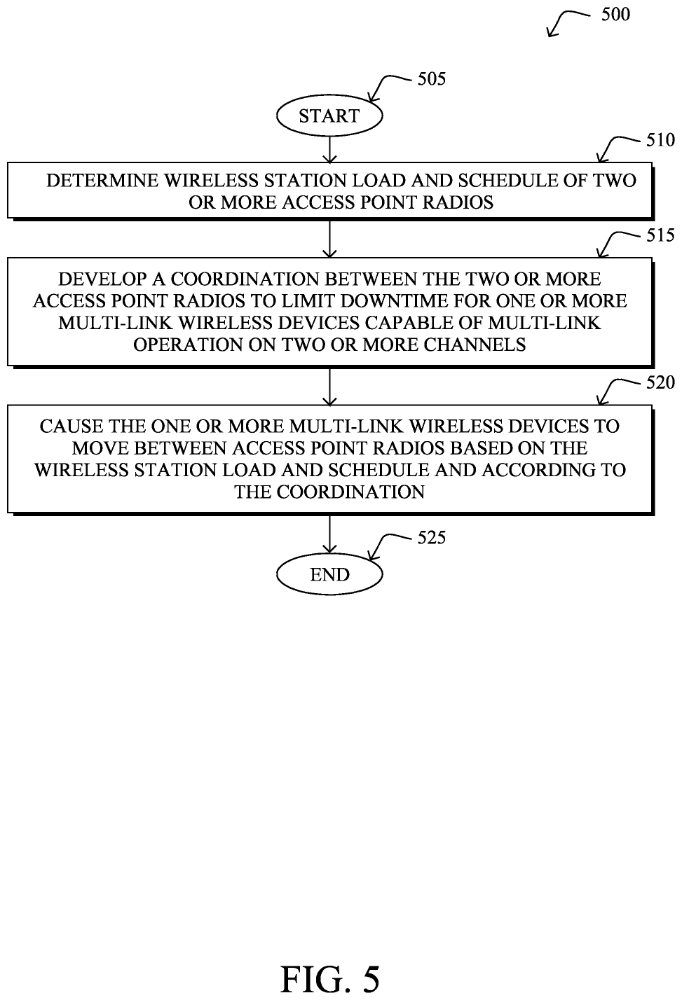

FIG. 5 illustrates an example simplified procedure for multi-link operation load balancing for a virtual access point in accordance with one or more embodiments described herein. For example, a non-generic, specifically configured device (e.g., an apparatus, such as device 200) may perform procedure 500 by executing stored instructions (e.g., process 248, a method). The procedure 500 may start at step 505, and continues to step 510, where, as described in greater detail above, a process determines wireless station load and schedule of two or more access point radios.

At step 515, as detailed above, the process develops a coordination between the two or more access point radios to limit downtime for one or more multi-link wireless devices capable of multi-link operation on two or more channels.

At step 520, as detailed above, the process causes the one or more multi-link wireless devices to move between access point radios based on the wireless station load and schedule and according to the coordination.

Procedure 500 then ends at step 525.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for improved load balancing in a network that includes VAPs by leveraging MLO to increase the time availability for each STA with said STA's corresponding VAP. In contrast to some previous approaches, the disclosure generally does not seek to double the number of connections to double the available airtime, but rather to use MLO to suppress available downtime.

According to the embodiments herein, an illustrative method herein may comprise: determining, by a process, wireless station load and schedule of two or more access point radios; developing, by the process, a coordination between the two or more access point radios to limit downtime for one or more multi-link wireless devices capable of multi-link operation on two or more channels; and causing, by the process, the one or more multi-link wireless devices to move between access point radios based on the wireless station load and schedule and according to the coordination.

In one embodiment, a particular multi-link wireless device of the one or more multi-link wireless devices is associated to a first radio with a first BSSID and a second radio with a second BSSID, and the method further comprises: communicating, by a first access point, a first BSSID on a third radio channel to the particular multi-link wireless device; communicating, by a second access point, a command to instruct the particular multi-link wireless device to look for a second BSSID on the third radio channel; and scanning, by the particular multi-link wireless device and while in communication with the first access point, to locate the second BSSID on the third radio channel and connect thereto. In one embodiment, the method further comprises: communicating, by the first access point, the first BSSID on the third radio channel to the particular multi-link wireless device using a neighbor report message. In one embodiment, the method further comprises: communicating, by the second access point, the command to instruct the particular multi-link wireless device to look for the second BSSID on the third radio channel using a request to roam message.

In one embodiment, the two or more access point radios comprise two or more radios on a single access point.

In one embodiment, the two or more access point radios comprise a single access point radio on each of two or more access points.

In one embodiment, causing the one or more multi-link wireless devices to move between access point radios comprises: setting a sleep bit on a first access point; and unsetting a sleep bit on a second access point.

In one embodiment, causing the one or more multi-link wireless devices to move between access point radios comprises: setting a target wake time for at least one access point.

In one embodiment, the method further comprises: determining that a particular multi-link wireless device of the one or more multi-link wireless devices is a candidate to move based on a load balancing operation.

In one embodiment, the wireless station load comprises airtime consumed over a given channel for each multi-link wireless device associated with a particular access point.

In one embodiment, the schedule comprises time slices for a given access point on each channel of a plurality of channels in response to that given access point hops between channels.

In one embodiment, the process is performed by one of: an access point, a virtual access point, or a wireless local area network controller.

In one embodiment, the method further comprises: determining the wireless station load and schedule of the two or more access point radios based on an exchange between the two or more access point radios.

In one embodiment, the method further comprises: determining the wireless station load and schedule of two or more access point radios based on an exchange from the two or more access point radios to a wireless local area network controller.

In one embodiment, the access point radios are deployed with an access point that is configured as a virtual access point.

According to the embodiments herein, an illustrative apparatus herein may comprise: one or more network interfaces to communicate with a network; a processor coupled to the one or more network interfaces and configured to execute one or more processes; and a memory configured to store a process that is executable by the processor, the process, when executed, configured to: determine wireless station load and schedule of two or more access point radios; develop a coordination between the two or more access point radios to limit downtime for one or more multi-link wireless devices capable of multi-link operation on two or more channels; and cause the one or more multi-link wireless devices to move between access point radios based on the wireless station load and schedule and according to the coordination.

According to the embodiments herein, an illustrative tangible, non-transitory, computer-readable medium may have computer-executable instructions stored thereon that, when executed by a processor on a computer, cause the computer to perform a method comprising: determining wireless station load and schedule of two or more access point radios; developing a coordination between the two or more access point radios to limit downtime for one or more multi-link wireless devices capable of multi-link operation on two or more channels; and causing the one or more multi-link wireless devices to move between access point radios based on the wireless station load and schedule and according to the coordination.

While there have been shown and described illustrative embodiments that provide for multi-link operation load balancing for a virtual access point, it is to be understood that various other adaptations and modifications may be made within the spirit and scope of the embodiments herein. For example, while certain embodiments are described herein with respect to using certain techniques for purposes of load balancing virtual access points, the techniques are not limited as such and may be used for other functions, in other embodiments. In addition, while certain protocols are shown, other suitable protocols may be used, accordingly.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having computer-executable program instructions stored thereon that execute on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining, by a process, wireless station load and schedule of two or more access point radios;
developing, by the process, a coordination between the two or more access point radios to limit downtime for one or more multi-link wireless devices capable of multi-link operation on two or more channels; and
causing, by the process, the one or more multi-link wireless devices to move between access point radios based on the wireless station load and schedule and according to the coordination.

2. The method as in claim 1, wherein a particular multi-link wireless device of the one or more multi-link wireless devices is associated to a first radio with a first BSSID and a second radio with a second BSSID, the method further comprising:
communicating, by a first access point, a first BSSID on a third radio channel to the particular multi-link wireless device;
communicating, by a second access point, a command to instruct the particular multi-link wireless device to look for a second BSSID on the third radio channel; and
scanning, by the particular multi-link wireless device and while in communication with the first access point, to locate the second BSSID on the third radio channel and connect thereto.

3. The method as in claim 2, further comprising:
communicating, by the first access point, the first BSSID on the third radio channel to the particular multi-link wireless device using a neighbor report message.

4. The method as in claim 2, further comprising:
communicating, by the second access point, the command to instruct the particular multi-link wireless device to look for the second BSSID on the third radio channel using a request to roam message.

5. The method as in claim 1, wherein the two or more access point radios comprise two or more radios on a single access point.

6. The method as in claim 1, wherein the two or more access point radios comprise a single access point radio on each of two or more access points.

7. The method as in claim 1, wherein causing the one or more multi-link wireless devices to move between access point radios comprises:
setting a sleep bit on a first access point; and
unsetting a sleep bit on a second access point.

8. The method as in claim 1, wherein causing the one or more multi-link wireless devices to move between access point radios comprises:
setting a target wake time for at least one access point.

9. The method as in claim 1, further comprising:
determining that a particular multi-link wireless device of the one or more multi-link wireless devices is a candidate to move based on a load balancing operation.

10. The method as in claim 1, wherein the wireless station load comprises airtime consumed over a given channel for each multi-link wireless device associated with a particular access point.

11. The method as in claim 1, wherein the schedule comprises time slices for a given access point on each channel of a plurality of channels in response to that given access point hops between channels.

12. The method as in claim 1, wherein the process is performed by one of: an access point, a virtual access point, or a wireless local area network controller.

13. The method as in claim 1, further comprising:
determining the wireless station load and schedule of the two or more access point radios based on an exchange between the two or more access point radios.

14. The method as in claim 1, further comprising:
determining the wireless station load and schedule of two or more access point radios based on an exchange from the two or more access point radios to a wireless local area network controller.

15. The method as in claim 1, wherein the access point radios are deployed with an access point that is configured as a virtual access point.

16. A tangible, non-transitory, computer-readable medium storing program instructions that cause a supervisory device in a network to execute a process comprising:
determining wireless station load and schedule of two or more access point radios;
developing a coordination between the two or more access point radios to limit downtime for one or more multi-link wireless devices capable of multi-link operation on two or more channels; and
causing the one or more multi-link wireless devices to move between access point radios based on the wireless station load and schedule and according to the coordination.

17. The tangible, non-transitory, computer-readable medium as in claim 16, wherein a particular multi-link wireless device of the one or more multi-link wireless devices is associated to a first radio with a first BSSID and a second radio with a second BSSID, and wherein:
a first access point communicates a first BSSID on a third radio channel to the particular multi-link wireless device;
a second access point communicates a command to instruct the particular multi-link wireless device to look for a second BSSID on the third radio channel; and
the particular multi-link wireless device then scans, while in communication with the first access point, to locate the second BSSID on the third radio channel and connect thereto.

18. The tangible, non-transitory, computer-readable medium as in claim 16, wherein the two or more access point radios comprise one of either: two or more radios on a single access point, or a single access point radio on each of two or more access points.

19. The tangible, non-transitory, computer-readable medium as in claim 16, wherein the access point radios are deployed with an access point that is configured as a virtual access point.

20. An apparatus, comprising:
one or more network interfaces to communicate with a network;
a processor coupled to the one or more network interfaces and configured to execute one or more processes; and
a memory configured to store a process that is executable by the processor, the process when executed configured to:
determine wireless station load and schedule of two or more access point radios;
develop a coordination between the two or more access point radios to limit downtime for one or more multi-link wireless devices capable of multi-link operation on two or more channels; and
cause the one or more multi-link wireless devices to move between access point radios based on the wireless station load and schedule and according to the coordination.
